(19) United States
(12) Patent Application Publication
(10) Pub. No.: US 2007/0200381 A1
(43) Pub. Date: Aug. 30, 2007

(54) Backsplash cradle apparatus and methods for securing bulky items

(76) Inventor: John R. Weise, Meguon, WI (US)

Correspondence Address: RYAN KROMHOLZ & MANION, S.C., POST OFFICE BOX 26618, MILWAUKEE, WI, 53226, US

(21) Appl. No.: 11/654,047

(22) Filed: Jan. 17, 2007

Related U.S. Application Data
(60) Provisional application No. 60/777,399, filed on Feb. 28, 2006.

(51) Int. Cl. B60P 3/00

(52) U.S. Cl. 296/3

(57) ABSTRACT

A cradle is disclosed to provide for secure transportation of construction materials, such as a backsplash, between upper and lower support members, a back member and associated clips.

### RELATED APPLICATION

This application claims the benefit of U.S. Provisional Patent Application Ser. No. 60/777,399, filed Feb. 28, 2006, and entitled “Backsplash Cradle Apparatus and Methods for Securing Bulky Items.”

### BACKGROUND OF THE INVENTION

This invention is directed to an article carrier for transporting articles such as stone or plate glass. A pickup truck, being a small truck, is normally used to deliver articles on short trips. Large trucks, freight cars and other enclosed carriers are normally used to haul articles on long trips. Other racks used in the glass industry are mounted on small trucks, pickup trucks or are completely enclosed inside of a delivery vehicle.

Particularly, this invention is configured to optimally carry stone backsplashes. A backsplash is an important element to most successful kitchen installations. It performs a vital role as a splash-guard to the back wall, particularly around the stove area, and keeps water from leaking behind the cabinetry. It is also an invaluable ‘mask’—hiding the gaps where a straight counter meets with a less-than-straight wall as is typical in older houses.

The present invention can be used in conjunction with truck mounted carriers such as that shown in U.S. Design Pat. 423447, owned by the common assignee hereof, and incorporated herein by reference.

### SUMMARY OF THE INVENTION

A cradle to securely and safely transport a kitchen backsplash is disclosed. In a preferred embodiment, front stop and rubber coated stainless steel fasteners prevent unwanted movement of the bulky article during transport. The cradle can be used on driver side or passenger side, van racks or pick up racks. The cradle can also be used on interior racks in cargo or cube vans.

### BRIEF DESCRIPTION OF THE DRAWINGS

FIG. 1 is a perspective view of a preferred embodiment of the present invention employed on a vehicle such as a truck;

FIG. 2 is a front perspective view of a preferred embodiment of the present invention;

FIG. 3 is a rear perspective view of a preferred embodiment of the present invention;

FIG. 4 is a rear side view of a preferred embodiment of the present invention.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

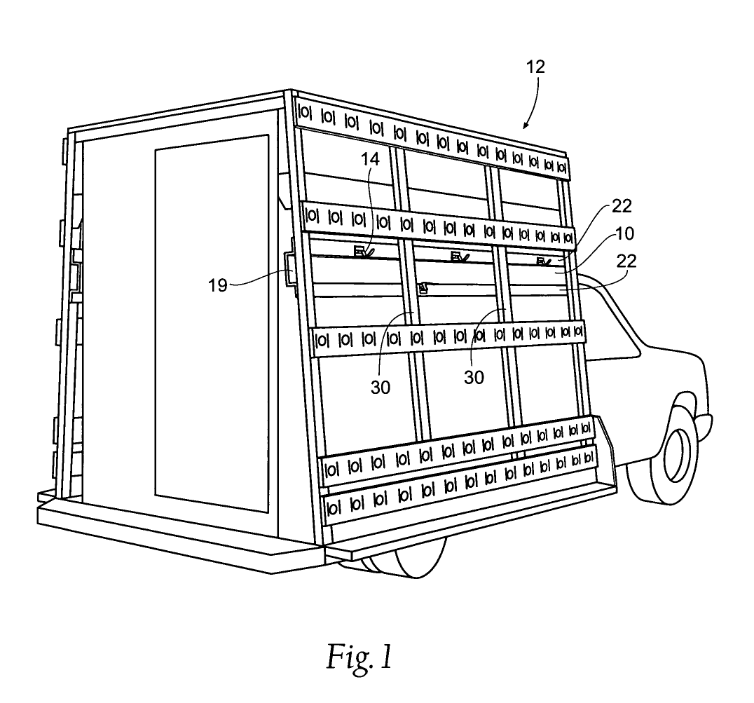

Referring now to FIG. 1, a perspective view of a preferred embodiment of the present invention is shown. As can be seen, it is preferable to incorporate a backsplash cradle 10 into a truck mounted carrier 12, the carrier 12 being used for carrying other parts for a construction project, such as window, drywall, stone, etc. Cradle 10 carries backsplash 20 (shown in FIG. 3) vertically between an upper and a lower support member 22. A series of clips 14, preferably spring biased, and preferably coated to minimize damage to backsplash 20, are provided to hold the backsplash 20 against the back member 16. In this fashion, an otherwise clumsy backsplash 20 is concealed in a convenient fashion on an interior portion of truck mounted carrier 12. Carrier 12 can then be used to support remaining portions of the project, in the case of a backsplash 20, a likely combination is that carrier 12 receives other countertop structure, granite or otherwise.

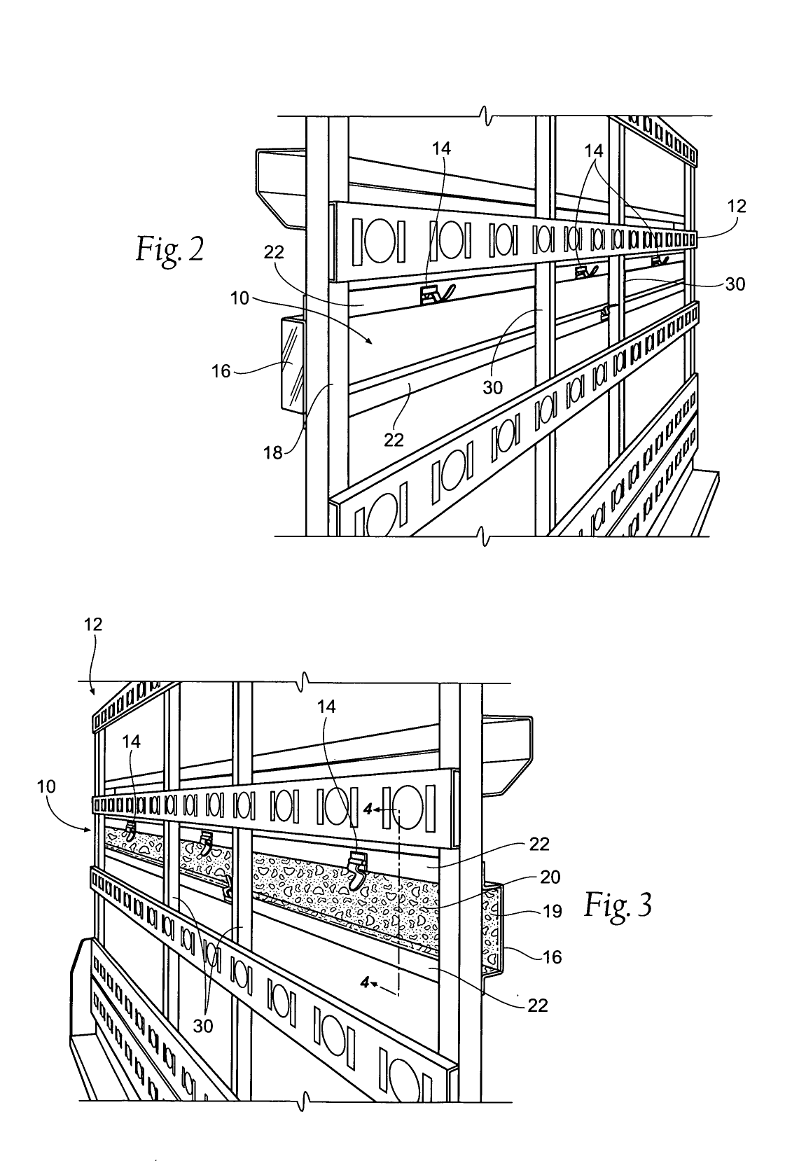

Referring now to FIG. 2 a front perspective view of a preferred embodiment of the present invention, with portions cut away is shown. In this view, it is evident that the cradle 10 of the present invention provides for secure transportation of backsplash 20 between upper and lower support members 22, the back member 16, and clips 14.

Backsplash 20 is preferably contained in a first horizontal direction at a first end by end member 18, and can optionally be contained along a lateral horizontal direction, along a length of the backsplash 20 by middle members 30. A back member 16 carries the backsplash 20 in the lateral horizontal direction.

Referring now to FIG. 3, is a rear perspective view of a preferred embodiment of the present invention is shown. In this view, it is seen that the backsplash 20 can be slid into the cradle 10, and is retained against the back member 16 by the clips 14. It is noted that the back member 16 is preferably open on one end (either the front or the rear end, the rear end shown open on FIG. 3) in order that the backsplash 20 can be slid into the channel created thereby, and retained against the opposite end (see reference numeral 16 on FIG. 2). In this manner, the back member 16 creates an end member on the closed end.

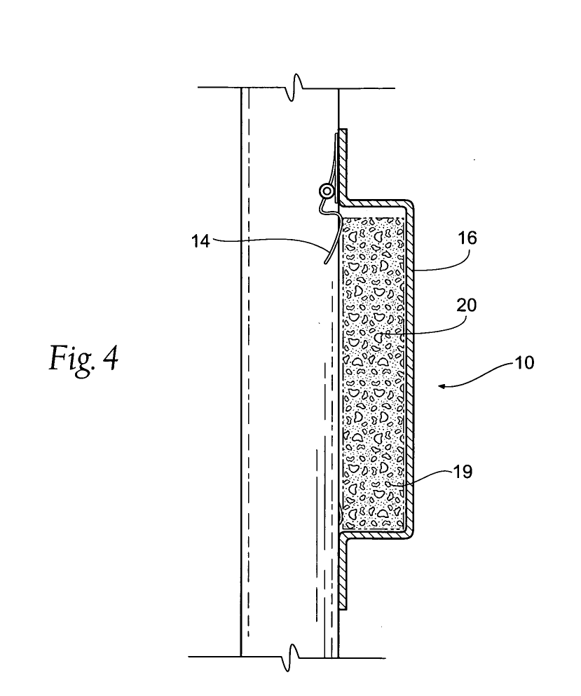

Referring now to FIG. 4, a rear side view of a preferred embodiment of the present invention is shown. In this view, it is seen that clips 14 urge the backsplash 20 against the back member 16.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

I Claim:

1. An apparatus for holding construction materials, the apparatus comprising:
a truck mounted carrier for carrying construction materials;
an upper and a lower support member,
a rear support member having two ends, a first open end for accepting a backsplash and a second closed end for retaining the backsplash;
a plurality of clips for urging said backsplash against said rear support member.
